(19) United States
(12) Patent Application Publication
(10) Pub. No.: US 2024/0078786 A1
(43) Pub. Date: Mar. 7, 2024

(54) METHOD FOR COMPARING IMAGES REPRESENTATIVE OF A GRAPHIC USER INTERFACE AND COMPUTER-READABLE STORAGE MEDIA

(71) Applicant: Instituto de Pesquisas Eldorado, Campinas (BR)

(72) Inventors: Guilherme RAMIREZ, Sao Paulo (BR); Nícolas RICCIERI GARDIN ASSUMPÇÃO, Campinas (BR); Samuel HENRIQUE POLLA, Paulinia (BR); Daniel GARDIN GRATTI, Campinas (BR)

(73) Assignee: Instituto de Pesquisas Eldorado, Campinas (BR)

(21) Appl. No.: 18/231,360

(22) Filed: Aug. 8, 2023

(30) Foreign Application Priority Data
Aug. 8, 2022 (BR) BR102022015685-9
Aug. 3, 2023 (BR) BR1020230156673

(51) Int. Cl. G06V 10/74

(52) U.S. Cl. CPC G06V 10/761; G06V 2201/07

(57) ABSTRACT

The present invention relates to a method (100) for comparing representative images of a graphical user interface, GUI, comprising: taking a read (110) on a first image (11) and a second image (12) to determine (120) descriptors (16) representative of characteristics of each of the first image (11) and second image (12); grouping (130) the adjacent descriptors (16) to form one or more elements (17); calculating the similarity between each of the one or more elements (17) of the second image (11) and each of the one or more elements (17) of the first image (12); determine (140) matching pairs (19) of each of the one or more elements (17) of the first image (11) with the element (17) of the second image (12) with the highest similarity about the respective element (17) of the second image (11); determining (150) that one or more elements (17) in the first image (12) has one or more matching elements (17) in the second image (11) based on the matching pairs (19); if one or more elements (17) of the second image (11) have one or more corresponding elements (17) in the first image (12), checking (160) the relative position of the one or more elements (17) in the first image (12)) corresponding with respect to the position of the one or more elements (17) corresponding in the second image (11).

### RELATED APPLICATIONS

This application claims the benefit of priority of Brazil Patent Application Nos. BR1020230156673 filed on Aug. 3, 2023 and BR102022015685-9 filed on Aug. 8, 2022, the contents of which are incorporated by reference as if fully set forth herein in their entirety.

### FIELD AND BACKGROUND OF THE INVENTION

The present invention relates to a method that uses computer vision to compare screenshots of graphical user interfaces (GUI) to evaluate missing, additional, and misplaced elements. Specifically, the method compares modifications to the GUI of versions of websites, applications, software, and/or the like with the goal of replacing or minimizing the use of human testers.

The presence of visual anomalies in the user interface, is difficult for automated systems to detect, although they are usually easily noticed by human testers. From the analysis of the state of the art, several computer vision techniques seek to recognize elements present in images.

The paper “Feature Matching-based Approaches to Improve the Robustness of Android Visual GUI Testing” by authors Luca Ardito, Andrea Bottino, Riccardo Coppola, Fabrizio Lamberti, Francesco Manigrasso, Lia Morra, and Marco Torchiano reveals two algorithms for widget matching (grouping/clustering descriptors that identify objects/image elements) to perform GUI testing in a visual way. In the first algorithm, a comparison is made from a specific widget and the entire screen. In the second algorithm, a comparison is made between two entire screens. The proposal is to compare two screenshots, where the comparison algorithm determines each virtual locator in the source screenshot, its location or absence in the target image. For this analysis, comparison algorithms are used that identify in the target image the location of a region of the source image that represents the widget to be compared. Under these conditions, the comparison algorithm can be handled in two ways: comparison of two entire screens or comparison of specific widgets to an entire screen. The identification of the position of the visual locator is based on established feature comparison techniques (such as SIFT—Scale-Invariant Feature Transform). These techniques work as follows: first, the best match between descriptors is calculated using an appropriate metric in feature space (e.g., Euclidean distance). Then, since the extracted feature point pairs may suffer from significant matching errors or mismatches in pairing, a common strategy is to post-process candidate matches with robust data fitting techniques such as Random Sample Consensus (RANSAC).

The paper “Article identification for inventory list in a warehouse environment” by author Yang Gao reveals an image recognition method and system to locate objects/products arranged on a pallet in a warehouse. The method has five steps, where a sample image representing the product to be identified and located in the test image, which represents the pallet, is inserted into the system input and SIFT features (descriptors) are extracted. Then the SIFT features of the test image are compared with a set of SIFT features in the image of the pallet laid out in the warehouse. After matching/comparing, there are a certain number of mistaken matches, and to decrease this factor, a threshold is applied to the matching pairs. After applying the threshold, a clustering algorithm called DBSCAN (Density-Based Spatial Clustering of Applications with Noise) is used for the purpose of separating the matching features into several clusters. Finally, even after applying the threshold and the DBSCAN algorithm, there is still a certain significant amount of mismatched matching pairs. To improve matching, the RANSAC method is applied to verify that a SIFT feature cluster meets the geometric transformation model between the sample image (representing the product) and the test image (representing the pallet in the warehouse).

The patent document U.S. Pat. No. 6,898,764B2 discloses a method, a system, and a program product for determining the differences between an existing GUI mapping file and a current GUI. A first list of objects based on an existing GUI mapping file (i.e., belonging to a previous version of a software program) is generated recursively. A second object list based on a current GUI (i.e., belonging to a current version of a software program) is also generated recursively. The two lists are then compared to determine whether any GUI objects have been changed (added or removed) between the previous and current versions of the software. The method determines the differences between an existing GUI mapping file and a current GUI. Each mapping file is built from screenshots of the GUI. Specifically, the method comprises: recursively building a first list of GUI objects based on the existing GUI mapping file; recursively building a second list of GUI objects based on the current GUI; and determining the differences between the existing GUI mapping file and the current GUI by comparing the first list with the second list.

A recurrent problem in the state of the art is that while the use of descriptors makes it possible to identify relevant points in an image to later compare whether these same points exist in the reference image, comparing descriptors and searching for matches in the other image can generate matches of a descriptor in the reference image with several other similar or identical descriptors that do not actually represent the element being compared.

Thus, to solve this problem, existing state-of-the-art solutions require an additional step of parameter estimation of the mathematical model, commonly using the RANSAC method, to obtain a satisfactory match of the descriptors of the two images. This approach generates computational cost in terms of processing and a longer time to execute the method computationally.

Furthermore, the prior art fails to reveal the identification of misplaced elements when comparing the screenshot of the two screens. Thus, prior art also does not discloses an solution to prevent evaluation of undesirable areas from the automatic detection, neither via dynamical elements nor via low correlation areas already known by the developers.

An object of the present invention is to provide a computer-implemented method for testing graphical user interfaces of software, web sites, applications, and/or the like and to replace or minimize the use of human testers to make the automated test execution less tolerant of visual problems.

Another objective is to mitigate the mismatch between descriptors when comparing two screenshots representing versions of a user interface of a software, website, or application, without the use of a mathematical model parameter estimation method.

### SUMMARY OF THE INVENTION

The present invention relates to a method for comparing representative images of a graphical user interface, GUI, comprising: performing a scan on a first image a second image to determine descriptors representative of features of each of the first image and second image; grouping the nearby descriptors to form one or more elements; calculating a correspondence correlation between each of the one or more elements in the first image and each of them in the second image, wherein the correspondence correlation is determined by similarity or difference between each of one or more elements of the first image and each of one or more elements of the second image; determining matching pairs of each of the one or more elements in the second image with one or more elements in the first image in order to maximize the similarity measures; determine that one or more elements in the second image has one or more corresponding elements in the first image based on the matching pairs; if one or more elements in the second image have one or more corresponding elements in the first image, check the relative position of the corresponding one or more elements in the second image with respect to the position of the corresponding one or more elements in the first image.

This invention also relates to a computer-readable storage medium comprising computer-readable instructions which, when executed by one or more processors, cause the one or more processors to perform the method of the present invention.

### BRIEF DESCRIPTION OF THE SEVERAL VIEWS OF THE DRAWINGS

A fuller understanding of this disclosure can be obtained by reference to the detailed description when considered in conjunction with the illustrative Figures that follow.

FIG. 1 is a block diagram representing the inputs and outputs of the method for comparing screens of a graphical user interface (GUI) according to an embodiment of the present invention.

FIG. 2 is a flowchart of the method for comparing screens of a graphical user interface (GUI) according to an embodiment of the present invention.

FIG. 3 illustrates the performance of some image descriptor extraction algorithms according to one embodiment of the present invention.

FIG. 4 illustrates the clustering/grouping of descriptors on a GUI screen according to an embodiment of the present invention.

FIG. 5 illustrates the operation of the method when comparing similar elements in the image according to an embodiment of the present invention.

FIG. 6 illustrates the operation of the method when two groupings of the reference image have as correspondents the same grouping of the test image, according to an embodiment of the present invention.

FIG. 7 illustrates the operation of the method when there are additional elements in the test image according to an embodiment of the present invention.

FIG. 8 illustrates the operation of the method when there are missing elements in the test image, according to an embodiment of the present invention.

FIG. 9 illustrates the operation of the method when there are misplaced elements in the test image, according to an embodiment of the present invention.

FIG. 10 illustrates the undesirable area detection function in a test image, according to an embodiment of the present invention.

### DESCRIPTION OF SPECIFIC EMBODIMENTS OF THE INVENTION

The present invention relates to a method for comparing representative images of a graphical user interface, GUI, comprising: performing a scan on a first image a second image to determine descriptors representative of features of each of the first image and second image; grouping the nearby descriptors to form one or more elements; calculating the difference between each of the one or more elements in the first image and each of them in the second image or encoding images of each of the elements obtained in the previous step in their respective latent vector representation; determining matching pairs of each of the one or more elements in the second image with the elements in the first image wherein the similarity measures are maximized; determine that one or more elements in the second image has one or more corresponding elements in the first image based on the matching pairs; if one or more elements in the second image have one or more corresponding elements in the first image, check the relative position of the corresponding one or more elements in the second image with respect to the position of the corresponding one or more elements in the first image.

The detailed description of exemplary embodiments here refers to the attached drawings showing embodiments of the present invention. While these exemplary embodiments are described in sufficient detail to allow those versed in the technique to practice the disclosures, other embodiments may be realized and logical changes and adaptations in design and construction may be made in accordance with this disclosure and the teachings herein. As such, the detailed description here is presented for illustration purposes only, and not for limitation.

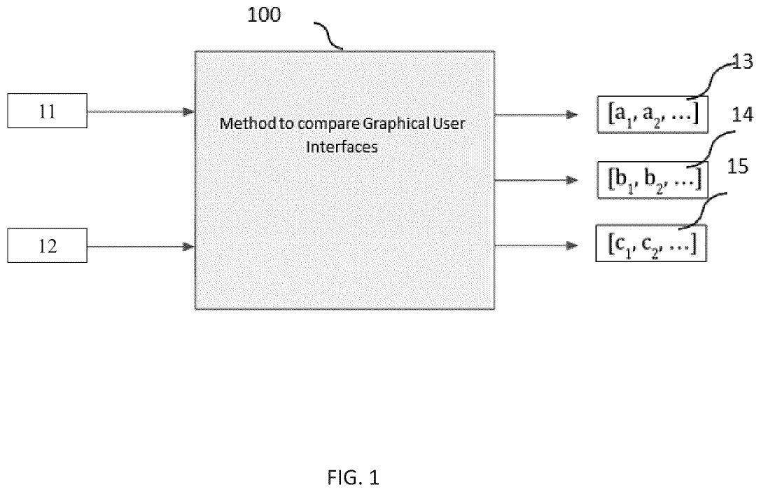

FIG. 1 reveals an overview of the 100 methods for comparing screens of a graphical user interface (GUI). Specifically, method 100 uses a first image 11, also called reference image 11, representative of a screenshot of a version of the GUI. For example, the first image 11 might be an earlier and previously validated (correct) version of the GUI, and compares it to a second image 12, also called test image 12 representing a screenshot of a current version to be validated of the GUI. After performing steps that will be explained in the following paragraphs, the method provides as output three lists containing missing elements 13, additional elements 14, and misplaced elements 15.

In this embodiment, the additional elements represent the elements present in test image 12 that are not present in reference image 11 and the missing elements represent the elements present in reference image 11 that are not present in test image 12.

In a preferred embodiment of the invention, the list is formed by identifiers of the classified elements, the identifiers representing a numerical value that locates one or more clusters, or groupings, related to the identifier. Alternatively, the method provides as output the reference image 11 next to the test image 12, where missing elements 13, additional elements 14 and misplaced elements 15 are visually highlighted directly in the reference and test images 11, 12.

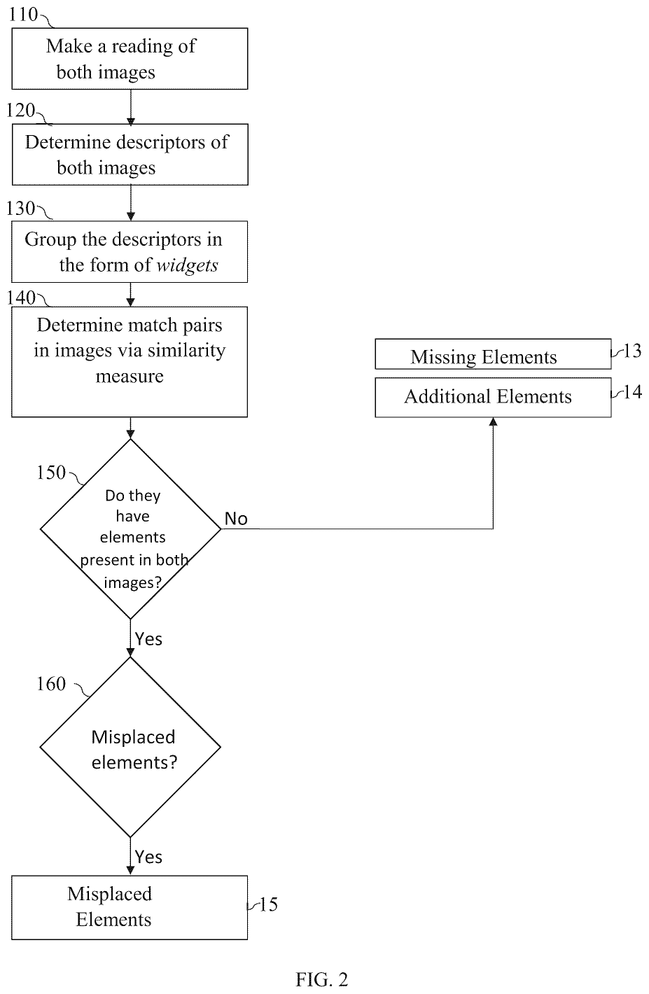

The method 100 will be described in more detail based on FIG. 2, which discloses a preferred but not limiting embodiment of the present invention.

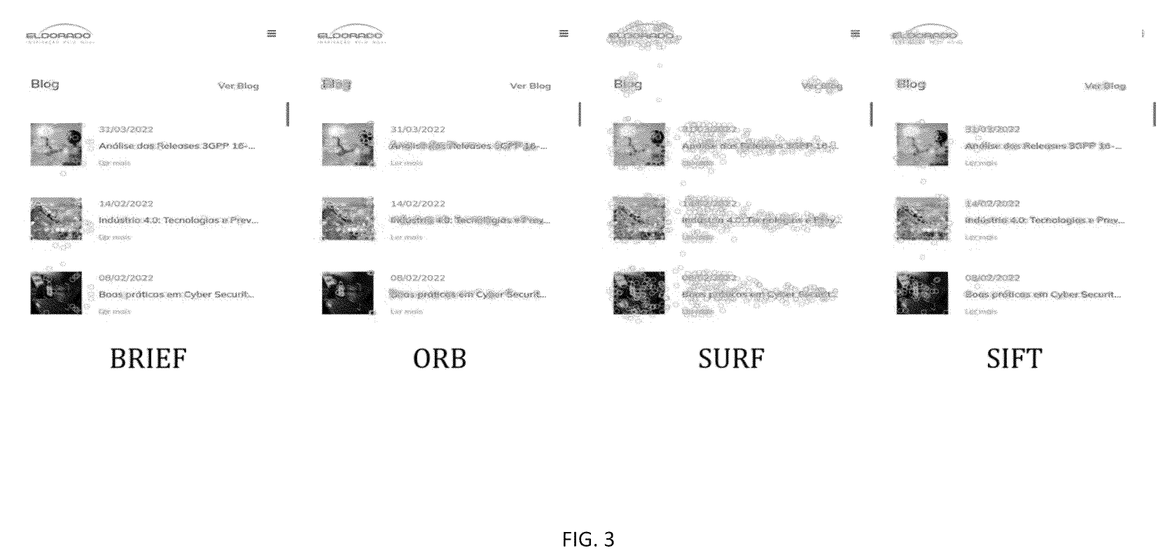

First, a state-of-the-art computer vision algorithm such as, but not limited to, AGAST, FAST, BRIEF, BRISK, ORB, or SIFT is used to scan 110 on the reference and test image 11, 12 to determine 120 all descriptors 16 representative of the features of the test image 12 and reference image 11, the descriptors 16 are also points of interest in the reference and test images 11, 12. Computer vision techniques usually present the descriptors 16 as points on the image. FIG. 3 reveals the performance of some computer vision algorithms for descriptor extraction 16 available in the prior art and that could be used for implementing the method 100 of the present invention.

In an optional embodiment, the SIFT or AGAST algorithm is used for descriptor extraction in the steps of taking a reading 110, identifying points of interest, and determining 120 of the method of this invention. From FIG. 3, the AGAST algorithm has a more satisfactory descriptor identification than the SIFT and BRISK algorithms. Another state-of-the-art computer vision algorithm is the SURF algorithm. The SURF algorithm has the advantages of producing a large number of dense points, particularly well on screens with well-separated elements or with elements with images. On the other hand, during the implementation of the present invention can occur a large production of noise and therefore the SURF is not suitable on screens whose background is not well behaved.

Descriptors 16 are used to provide a unique and robust description of each feature in an image by identifying points of interest in an image. Furthermore, a single screen can contain several thousand descriptors, all concentrated in a few elements (buttons, text, switches, etc.) forming descriptor clouds.

Returning to FIG. 2, after determining 120 of the descriptors 16 of the reference and test images 11, and 12, the method comprises clustering 130 of the descriptor clouds 16 into a few groups that represent the screen elements. In order to facilitate the description of the invention, the groups representing the screen elements will be referred to here as elements or widgets 17. The grouping step 130 comprises forming one or more elements 17 representative of objects from the reference and test image 11, 12. These one or more elements 17 are formed by clustering descriptors 16 using a data density clustering algorithm, such as DBSCAN.

Then a comparison of the reference image 11 with the test image 12, or vice versa, is performed, where brute force is used through an algorithm to determine 140 groups of similar widgets 17 in the test image 12 compared to the reference image 11, or vice versa. For example, the step of determining 140 can be done by a heuristic based on descriptors correlation, by brute force, or via a latent space encoder of elements.

Note that the grouping step 130, unlike the prior art, is performed before the step of determine matching 19 140 pairs. This reversal of steps compared to the prior art allows matching to be done between each of the one or more elements 17 and no longer between each descriptor 16, making for improved matching accuracy by decreasing the likelihood of performing matching between similar or identical descriptors that do not actually represent the element being compared. In this way, the present invention manages to eliminate the need for an additional step of applying a mathematical model parameter estimation method, which the prior art commonly uses the RANSAC method.

After the step of determining 140 matching pairs, the determination of 150 of which elements are present in the two images 11, and 12 is performed to generate two lists, one with the missing elements 13 [a₁, a₂, . . . ] and one with the additional elements 14 [b₁, b₂, . . . ]. Finally, we check 160 misplaced elements by calculating the distance of the pairs of elements 17 found to generate a list of misplaced elements 15 [c₁, c₂, . . . ].

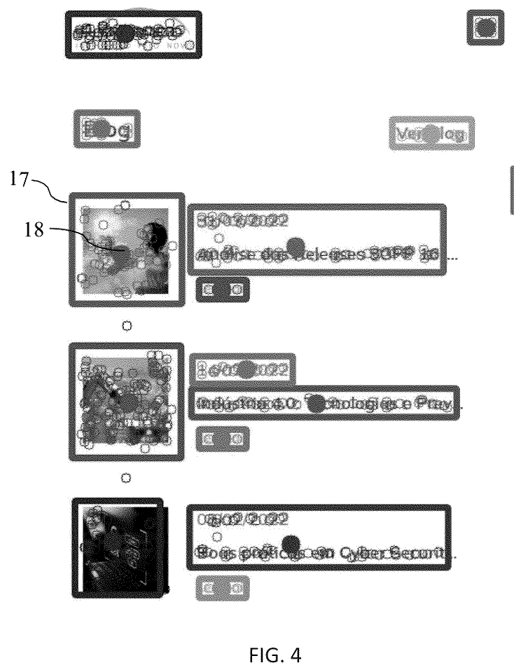

FIG. 4 reveals a screenshot after going through the step of grouping 130 the method descriptors 100 according to the present invention. The grouping step 130 is necessary since comparing descriptors 16 in the test image 12 and searching for matches in the reference image 11, or vice versa, can generate matches of a descriptor 16 in the reference image 11 with several other similar or identical descriptors in the test image 12 that do not actually represent the element being compared.

The grouping step 130 using preferentially, but not limited, a agglomerative variant of the DBSCAN algorithm, that comprises the realization of DBSCAN algorithm to obtain small internal groupings, which are delimited by boxes 17, called potential elements. Then, overlapping boxes are joined into a single potential element, until no box on one screen overlaps another. For this, the eps parameter of the algorithm is chosen so that descriptors of distinct visual elements do not erroneously group together and that descriptors of the same visual element belong to close groupings. A recommended heuristic is to use the elbow point detection algorithm (Elbow method), from the test of the variance of the data in relation to the number of clusters, in the distance curve of the nearest near-k of each screen descriptor, according to the DBSCAN algorithm described in Ester, Martin, et al. “A density-based algorithm for discovering clusters in large spatial databases with noise.” kdd. Vol. 96. No. 34. 1996.

As a result, each element 17 is identified with its boundaries 17 {(xₘᵢₙ, yₘᵢₙ), (xₘₐₓ, yₘₐₓ)} and centroid 18 (x_{average}, y_{average}) are established by finding the extreme values (maximum and minimum) on each of the axes (width and height) among all the coordinates of the points participating in element 17. The centroids 18, edges 17, and members of each element 17 are illustrated in FIG. 4.

Having one or more elements 17 of descriptors 16, the step of determining 140 begins, in which it is necessary to identify the correlations or matching pairs 19 between one or more elements 17 in the reference image 11 and the test image 12. To do this, a correspondence measure is defined between two elements 17 of descriptors 16. This will allow the identification of correspondence correlation between one element 17 in the reference image 11 and another in the test image 12 indicating that they are the most similar element. The correspondence relationship between elements 17 of reference image 11 and test image 12 can be determined by calculating the difference or similarity.

To calculate the correspondence correlation between two elements 17 one can non-limitingly, use the BFMatcher (Brute Force Matcher) algorithm which calculates the pairs of points (one in each image) whose corresponding descriptors 16 are most like each other. Using BFMatcher through the OpenCV library for Python, to calculate the distance between descriptors 16 the L2 standard was used, the BFMatcher standard is an input parameter that defines the metric to be used. Each of the one or more elements 17 in reference image 12 is compared with each of the one or more elements 17 in test image 11. BFMatcher determines 140 the correlation pairs 19 found. Whereas the reference image 11 has NR elements 17 forming the grouping set C^{R}={c^{R}₁, c^{R}₂, . . . , c^{R}_{NR}} and the test image 12 has NT elements 17 constituting the element set C^{T}={c^{T}₁, c^{T}₂, . . . , c^{T}_{NT}}. Given further that each element 17 is formed by nᵢ descriptors 16 {c_{i,1}, c_{i,2}, . . . , c_{i,ni}}. By submitting a pair of elements cᵢ∈C^{R} and cⱼ∈C^{T} (i.e., cᵢ is a cluster from reference image 11 and cⱼ is a element from test image 12), where i∈{1, . . . , N_{R}} and j∈{1, . . . , N_{T}} (cᵢ is one of the N_{R} elements obtained from reference screen 11C^{R} and cⱼ is one of the N_{T} element obtained from test screen 12C^{T}), of sizes nᵢ and nⱼ respectively, to the BFMatcher algorithm, the return consists of the set of matching pairs (19) M={(c^{R}ᵢ₁, c^{T}ⱼ₁), (c^{R}ᵢ₂, c^{T}ⱼ₂), . . . , (c^{R}_{iN}, c^{T}_{mN})} that represent the matching pairs of descriptors 16 between the two elements 17 cᵢ and cⱼ. Where {c^{R}ᵢ₁, c^{R}ᵢ₂, . . . , c^{R}_{iN}}⊆cᵢ and {c^{T}ⱼ₁, c^{T}ⱼ₂, . . . , c^{T}_{jN}}⊆cⱼ. The metric defined between elements cᵢ and cⱼ is defined as follows:

$$D ( {c}_{i} , {c}_{j} ) = [ 1 + \frac{1}{N} {\sum }_{m = 1}^{N} d ( {c}_{im} , {c}_{jm} ) ] {( \frac{{n}_{i} + {n}_{j}}{2 N} )}^{k}$$

where d(c^{R}ᵢₘ, c^{T}ⱼₘ) is the metric (using the L2 standard) between descriptors 16 c^{R}ᵢₘ and c^{T}ⱼₘ, nᵢ is the number of descriptors in element 17 cᵢ, nᵢ is the number of descriptors in element 17 cⱼ, N is the number of pairs of matching descriptors found between elements cᵢ and cⱼ and k is a penalty parameter for non-corresponding descriptors (additional and missing descriptors) and is obtained empirically, that is, it is determined on a case-by-case basis according to the objective of the project. The parameter k is also related to the error tolerance of the algorithm, the higher the k, the less tolerant the algorithm is. For example, if in reference image 11 it says ELDORADO and in test image 12 it says ELDORAD, element 17 in test image 12 will have at least one less descriptor than element 17 in reference image 11 due to the absence of the letter O. Thus, the setting of the parameter k will determine the tolerance for this difference to determine the similarity. That is, a high k will cause the algorithm to point out that the letter O is missing, while a lower k may cause the algorithm to point out no divergence between images 11, 12. With this difference value, it is possible to determine the similarity or the difference between according to embodiments of the present invention.

In a first modality, with this difference value, when two groupings 17 are composed of the same descriptors 16 the value of the difference will be 1, that is, when d(c^{R}ᵢₘ, c^{T}ⱼₘ)=0 for every m∈{1, . . . , N} and when N=nᵢ=nⱼ.

When comparing clusters 17 of the reference and test images 11, 12 by means of this metric, in fact we compare all the descriptors 16 of a cluster 17 of the reference image 11 with all the descriptors 16 of the cluster 17 of the image of test 12 and then an average is performed between the relative positions of correspondence 19 found, resulting in the mean between the relative distances between corresponding descriptors. This procedure is repeated in all one or more clusters 17 of reference image 11 with all one or more clusters of test image 12, generating a distance matrix between all possible pairs of clusters. At first, we will call the candidates of the first order to match the pairs (cᵢ, cₖ) that so D(cᵢ, cₖ) be minimal among all cₖ.

In a preferred modality, from the calculated difference value, we calculate the similarity between two elements through the equation:

$$S ( {c}_{i} , {c}_{j} ) = exp ( \frac{1}{2 σ} {( 1 - D ( {c}_{i} , {c}_{j} ) )}^{2} )$$

where σ is a value that determines flexibility when converting distance to similarity.

Another way to calculate the similarity between two elements 17, preferentially, but not limitingly, is by performing an encoding of elements 17 in a latent space of representation, for example, through the use of an artificial neural network. In which the encoding determines 140 similar elements through metrics, such as similarity by cosine, through the direct calculation of its encoded vector representation.

In this second embodiment, an artificial neural network is trained to generate low-dimensional vectors so that similar images of visual elements have a similar latent representation and distinct visual elements have distant latent vectors. Once trained, the network encodes the image of each of the one or more elements of the test image 12 and the one or more elements of the reference image 11 in their respective coded representations, and the similarity between two elements can be calculated through a measure of similarity between vectors.

Optionally, still in step 140, method 100 allows the possibility to ignore 17 elements determined within a specific area, predetermined manually or automatically, or through a list of elements to be ignored, in order to avoid the validation of unwanted elements.

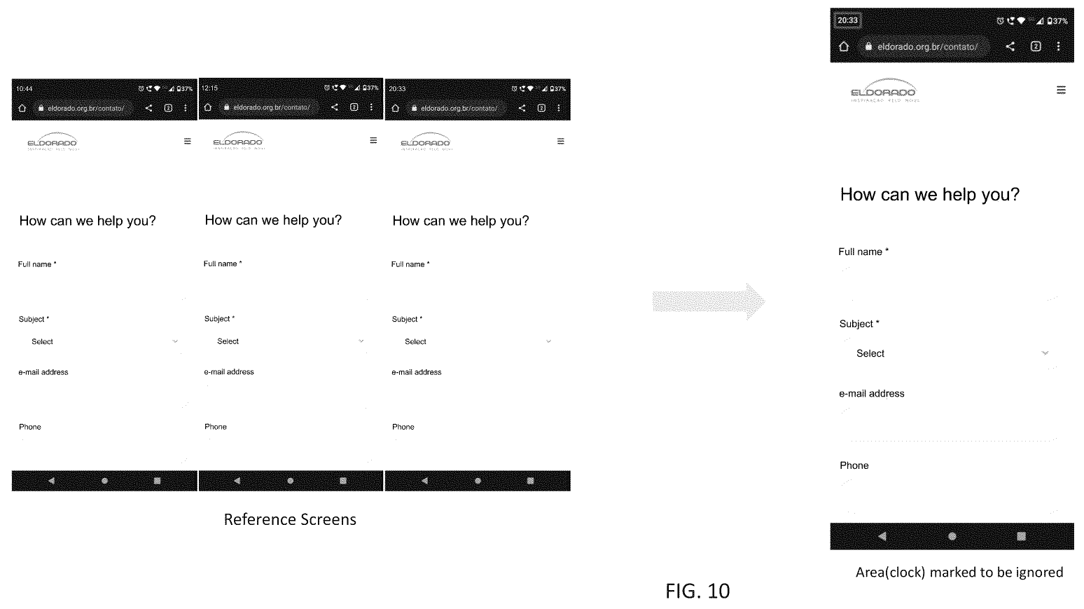

In order to exemplify this characteristic, FIG. 10 illustrates the operation of the optional method, which detects areas that can be demarcated as unwanted for evaluation. In the example there are several captures of the same reference screen, all without elements with problems, and the area of the clock at the top is demarcated as unwanted, because, even if there is a difference between the screens, the change in the element is not considered failure. To this end, areas of non-evaluation can be reported in reference images 11 and test 12, in order not to evaluate elements that are not of interest, such as, but not limited to, an element that displays a clock or element that changes frequently.

Preferentially, but not limited to, a method of ignoring elements in an unwanted area is through a correlational analysis to determine areas of low correspondence within a set of two or more reference images 11, which are tested progressively, storing uncorrelated elements and their respective areas. This information is then used, at the time of testing, to ignore elements more similar to an uncorrelated element and, elements in the areas of low correlation, determined in the previous step.

Then, still in determining step 140, method 100 comprises not consider as matching pairs 19 matching pairs 19 whose similarity is lower than a threshold (min_score), that is, if the pair (cᵢ, cⱼ) is ignored if S(cᵢ, cⱼ)<min_score , (min_score is obtained empirically, that is, it is determined case by case according to the project objective). Optionally, to avoid selecting too many candidates due to a very flexible threshold, a tolerance parameter is introduced, in which only matching pairs whose similarity is no more than the tolerance to the best matching pair for the same element 17 in the test image 12. Thus, elements 17 in reference image 11 that form matching pair candidates for the same element 17 in the test image should not have a similarity value much lower than that of the best pair for that element in the test image.

Candidates(cᵢ){cᵢ∈C^{R}:S(cᵢ, cⱼ)>max{min_score, S*(cⱼ)−tol}}

Where S*(cⱼ) is the highest similarity value among all matching pairs (cᵢ, cⱼ), for all cᵢ in the set of reference elements. If, for any element 17 cⱼ, the candidate set contains more than one element, the algorithm will choose element 17 in the set whose centroid 18 is closest to the relative position of the centroid 18 in element 17 of the test image 12 cⱼ. Thus, the winning match 19 will be the one with candidate cⱼ whose relative position of centroid 18 is most like the position of centroid 18 of element 17 cᵢ. To compare positions between screens with different dimensions, it is necessary to consider the potential differences between screen dimensions, standardizing the positions on the test screen for their respective relative position on the reference screen. If the reference image 11 has dimensions H_{R}×W_{R} (H_{R} being the height of the image in pixels and W_{R} its width also in pixels) and a test image 12 has dimensions H_{T}×W_{T}, a position (x, y) on the test phone 12 could be translated at position ({\hat{x}},{ŷ}) into an image the size of the reference image according to the following equation:

$$( \hat{x} , \hat{y} ) = ( \frac{{W}_{R}}{{W}_{T}} \cdot x , \frac{{H}_{R}}{{H}_{T}} \cdot y )$$

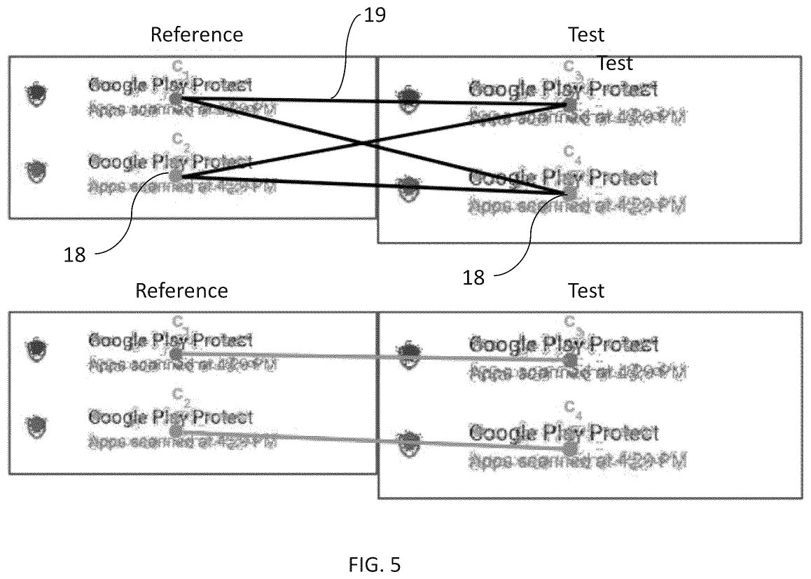

FIG. 5 reveals an exemplary embodiment, where the edges of the elements 17 have been hidden for better visualization and where C_{R}={c₁, c₂} and C_{T}={c₃, c₄}. As all elements 17 deal with the same visual element (“Google Play Protect”), S (cᵢ, cⱼ)≈1 whatever i={1, 2} and j={3, 4} (the scale slightly affects the descriptors found, so the difference is not necessarily exactly 1). Therefore, the candidates for c₃ and c₄ are {c₁, c₂}. To decide which correlation 19 wins, element 17 is chosen whose relative position of centroid 18 is closest to the expected centroid 18 of element 17 considering the scale of the test device 12. Thus, the 19 matching pairs are {(c₁, c₃), (c₂, c₄)}.

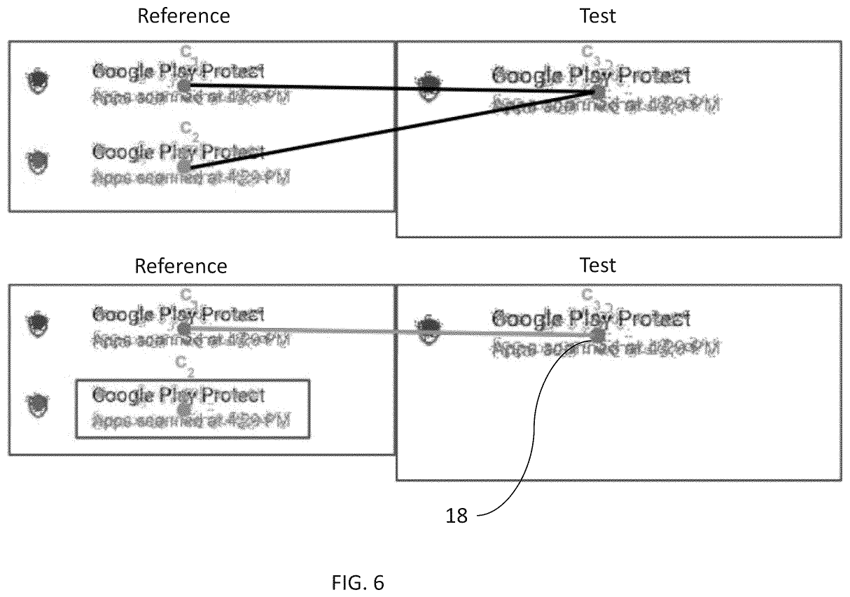

FIG. 6 shows an exemplary embodiment, in which two elements 17 of the reference image 11 correspond to the same element 17 of the test image 12. In this case, only the closest relative position match is considered.

In possession of the set of correspondence pairs 19 M between the one or more elements 17 of the images 11, 12, in the step of determining 150 one or more elements 17 present in the two images and in the step of verifying 160 if one or more elements 17 exist is poorly positioned it is possible to identify problems in the test image 12. The problems addressed in this document are additional element 14, missing element 13, and misplaced element 15. In a preferred embodiment, an additional element 14 consists of a element 17 found in test image 12 that is not present in the reference image 11. A missing element 13 consists of element 17 of the reference image 11 that is not found in test image 12. A misplaced element 15 consists of element 17 found in both images 11, and 12, but whose position in the test image 12 is not as predicted by the reference image 11.

In an optional embodiment, method 100 comprises comparing a test image 12 with a reference image 11. In that embodiment, the additional elements 14 represent the one or more elements 17 present in the reference image 11 that are not present in the test image 12 and the missing elements 13 represent the one or more elements 17 present in the test image 12 that are not present. present in the reference image 11.

In the step of determining 150 elements present in the two images, it is possible to indicate elements 17 on the test screen 12 that are not present on the reference screen 11, that is, additional elements 14. For this, it is enough to capture elements 17 of C^{T} that are not found as the second component in the set of matching pairs 19 M to form a list of additional elements 14, according to the following relationship:

Additional={cⱼ∈C^{T}:(cᵢ, cⱼ)∉M, ∀cᵢ∈C^{R}}

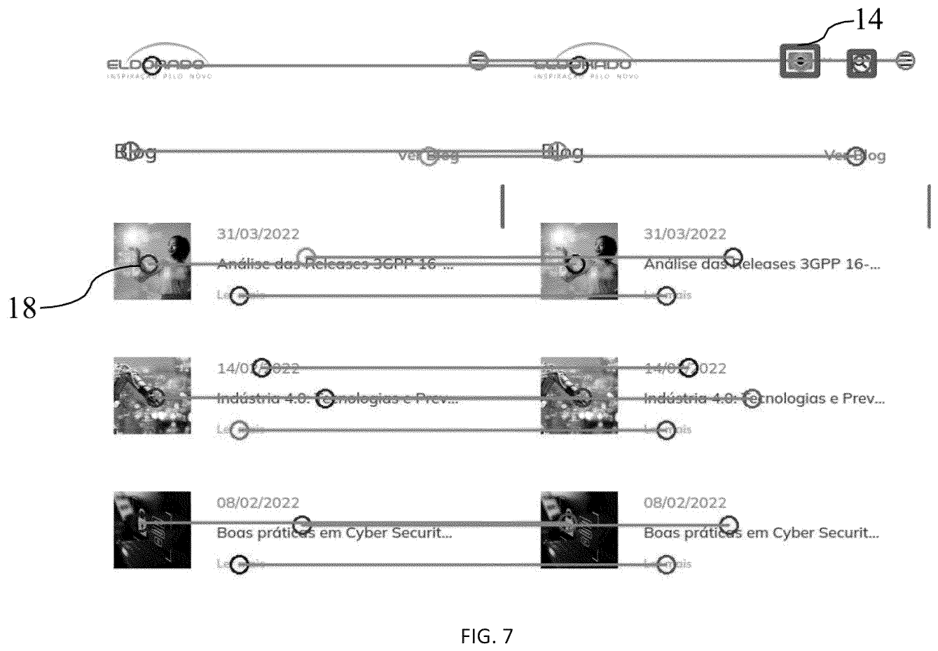

FIG. 7 reveals an embodiment of the present invention in which additional elements 14, specifically some icons, are shown on test screen 12, but are not present on reference screen 11.

The step of determining 150 the one or more elements 17 present in the two images further comprises finding missing elements 13. After finding all pairs of elements 17 whose similarity was lower than the min_score, in the step of not considering them as matching pairs 19, these pairs are discarded as matches 19, so that it is possible that some elements 17 of the reference image 11 are not present among the pairs of the set of match pairs 19 M. These elements 17 are considered missing in the test image 12 and are reported as failures in the comparison of images in a list of missing elements 13, according to the following relationship:

Absent={cᵢ∈C^{R}:(cᵢ, cⱼ)∉M, ∀cⱼ∈C^{T}}

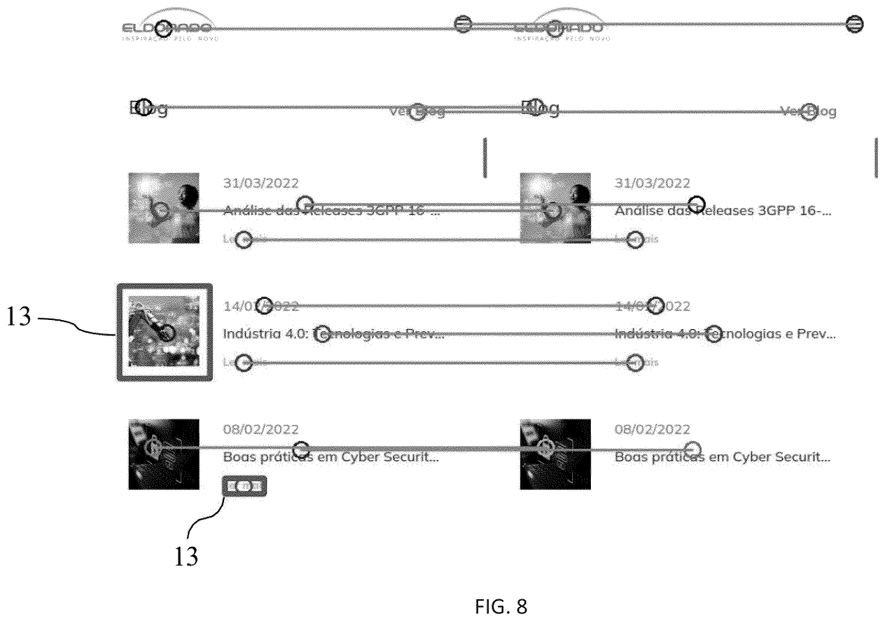

FIG. 8 reveals an embodiment of the present invention in which some elements (an icon and text) from reference image 11 were missing 13 from test image 12. Once the errors of additional elements 14 or missing elements 13 have been pointed out, the step of verifying 160 if a element 17 existing both in the reference image 11 and in the test image 12 is wrongly positioned, in which the positions of each pair of the set of 19 M matching pairs are evaluated. In this way, any pairs whose relative coordinates between centroids 18 of each corresponding element 17 differ more than a distance threshold (threshold_{distance}), obtained empirically, that is, it is determined on a case-by-case basis according to the project objective, this pair 19 is said the correspondence of 15 misplaced elements, according to the following relationship:

Misplaced={(cᵢ, cⱼ)∈M:\sqrt{(xᵢ−\hat{x}ⱼ)²+(yᵢ−ŷⱼ)²}≥threshold_{dist}}
where xᵢ and yᵢ represent the positions of each centroid 18 on the screen of the test device 12 across the test image 12 and \hat{x}ⱼ and ŷⱼ are the relative positions of each centroid 18 xᵢ and yᵢ on the screen of the reference device 11 across the reference image 11 found in the step of defining a relative position.

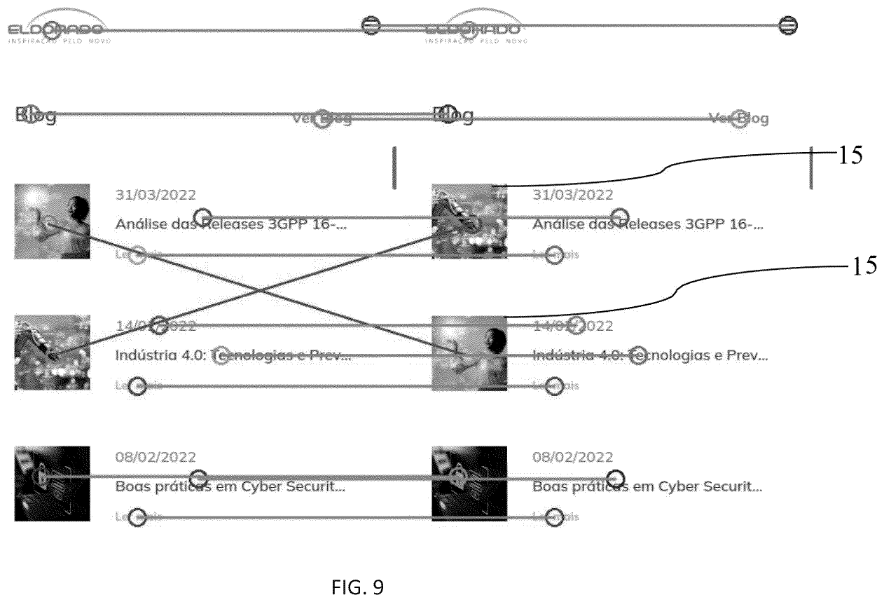

FIG. 9 reveals an embodiment of the present invention in which the misplaced elements 15 error occurred. In FIG. 9, two of the elements appear with their positions reversed. In a preferred embodiment of the invention, the list is formed by identifiers of the classified elements, the identifiers representative of a numerical value that locates the element 17 (explained in the next paragraphs) related to the identifier. In an optional embodiment of the invention, the method outputs the reference image 11 next to the test image 12, where missing elements 13, additional elements 14, and misplaced elements 15 are visually highlighted directly in the reference and test images 11, 12, in which the one or more elements 17 representative of the missing 13 or additional elements 14 are marked with a red colored line around them and the pair of elements 17 verified 160 as misplaced forms a matching pair 19 marked in red.

It is also noteworthy that this method is implemented in a computer according to the present invention. The computer comprises at least one processor and a computer-readable storage medium, which further comprises computer-readable instructions that, when executed by at least one or more processors, cause the computer to perform the method as required. present invention.

Accordingly, the example embodiments described herein can be implemented using hardware, software, or any combination thereof, and can be implemented on one or more computer systems or other processing systems. Additionally, one or more of the steps described in the exemplary embodiments set forth herein can be implemented, at least in part, by machines. Examples of machines that can be used to perform the operations of the example embodiments set forth herein include general-purpose digital computers, specially programmed computers, desktop computers, server computers, client computers, portable computers, mobile communication devices, tablets, and/or similar devices.

For example, an illustrative example system for performing the operations of the embodiments set forth herein may include one or more components, such as one or more processors or microprocessors, for performing the arithmetic and/or logical operations required to execute a computer program that performs the steps of the described method, and storage media, such as one or more disk drives or memory cards (e.g., flash memory) for program and data storage, and random access memory, for temporary data storage and program instruction.

The system may also include software residing on a storage medium (e.g., a disk drive or memory card), which, when executed, directs the processor(s) or microprocessor(s) to perform the steps of the method. The software may run on an operating system stored on the storage medium, for example, UNIX or Windows, Linux, Android, and the like, and may adhere to various protocols, such as Ethernet, ATM, TCP/IP protocols, and/or other connection or connectionless protocols.

As is well known in the art, microprocessors can run different operating systems and can contain different types of software, each type being devoted to a different function, such as manipulation and management of data/information coming from a particular source or transformation of data/information from one format to another format. The embodiments described herein are not to be construed as being limited to use with any particular type of server computer, and any other suitable type of device for facilitating the exchange and storage of information may be employed instead.

Embodiments of the method discussed herein may be performed by a computer program which may be provided as a computer program product, or software, which may include an article of manufacture on a non-transient machine-accessible or computer-readable medium (also referred to as “machine-readable medium”) with instructions. The instructions on the machine-accessible or machine-readable medium may be used to program a computer system or other electronic device. The machine-readable medium may include but is not limited to, floppy diskettes, optical disks, CD-ROMs, magneto-optical disks, or other types of machine-readable medium suitable for storing or transmitting electronic instructions.

The techniques described here are not limited to any particular software configuration. They can be applied in any computing or processing environment. The terms “machine-accessible medium”, “machine-readable medium” and “computer-readable medium” used herein shall include any transient or non-transient medium that can store, encoding, or transmitting a sequence of instructions for execution by the machine (for example, a CPU or other type of processing device) and which cause the machine to perform the method described here. Furthermore, it is common in technology to speak of software, in one form or another (e.g., program, procedure, process, application, module, unit, logic, and the like), as taking an action or causing a result. Such expressions are merely a quick way of stating that execution of software by a processing system causes the processor to perform an action to produce a result.

In this way, method 100 according to the present invention is attractive since when performing the comparison between elements 17 of the reference image 11 and the test image 12, it is possible to eliminate the parameter estimation step of the mathematical model with robust techniques of data adjustment present in the prior art, which is commonly done using methods such as RANSAC. Thus, the method described here saves computational processing and execution time and makes the execution of tests for software, websites, applications, and the like less tolerant to visual problems. Furthermore, the described method allows the determination of misplaced elements 15 from the comparison of screenshots of a reference image 11 and a test image 12.

Numerous variations affecting the scope of protection of this application are permitted. That way, it reinforces the fact that the present invention is not limited to the particular configurations/embodiments described above.

1. Method (100) for comparing representative images of a graphical user interface, GUI, characterized in that it comprises:
scanning (110) a first image (11) and a second image (12) to determine (120) descriptors (16) representative of characteristics of each of the first image (11) and second image (12);
grouping (130) the adjacent descriptors (16) to form one or more elements (17);
calculating the correspondence correlation between each of the one or more elements (17) of the first image (11) and each of the one or more elements (17) of the second image (12), wherein the correspondence relationship is determined by the similarity or difference between each of the one or more elements (17) of the first image (11) and each of the one or more elements (17) of the second image (12);
determine (140) matching pairs (19) of each of the one or more elements (17) of the second image (11) with element (17) of the first image (12) with the smallest difference in relation to the respective element (17) of the second image (11) based on the correspondence correlation;
determine (150) that one or more elements (17) in the first image (12) has one or more matching elements (17) in the second image (11) based on the matching pairs (19);
if one or more elements (17) of the second image (11) have one or more corresponding elements (17) in the first image (12), checking (160) the relative position of one or more elements (17) in the second image (12)) corresponding with respect to the position of the one or more elements (17) corresponding in the first image (11).

2. Method (100) according to claim 1, characterized in that the steps of taking a reading (110) and determining (120) are performed by a computer vision algorithm among BRISK, ORD, or SIFT, or preferably, SIFT or AGAST.

3. Method (100) according to claim 1, characterized in that the step of grouping (130) descriptors (16) is performed by an agglomerative variant of DBSCAN algorithm.

4. Method (100) according to claim 1, characterized in that the steps of calculating the similarity, ignoring elements (140) from a list of elements or undesirable areas, and determining (140) matching pairs (19) which could be performed by the BFMatcher algorithm or by a latent space encoder.

5. Method (100) according to claim 1, characterized in that before carrying out the step of determining (140) a step of defining a relative position between the first image (11) and the second image (12), according to the following equation:
$$( \hat{x} , \hat{y} ) = ( \frac{{W}_{R}}{{W}_{T}} \cdot x , \frac{{H}_{R}}{{H}_{T}} \cdot y )$$
in which:
(x, y): point in the second image (12);
(\hat{x}, ŷ): relative position in the first image (11) of the point in the second image (12);
H_{R}×W_{R}: device screen size of the first image (11);
H_{T}×W_{T}: device screen size of the second image (12).

6. Method (100) according to claim 1, characterized in that given a elements pair (17) is determined by cᵢ and cⱼ, where cᵢ is a elements (17) of the first image (11), cⱼ is a elements (17) of the second image (12), and determining (140) matching pairs (19) further comprises:
return matching pairs (19) M={(c^{R}ᵢ₁, c^{T}ⱼ₁), (c^{R}ᵢ₂, c^{T}ⱼ₂), . . . , (c^{R}_{iN}, c^{T}_{jN})} that represent the pairs of descriptors (16) corresponding between the two groupings 17 cᵢ and cⱼ, where i∈{1, . . . , N_{R}} and j∈{1, . . . , N_{T}}, N_{R} represents the number of groupings (17) of the first image (11), N_{T} represents the number of groupings (17) of the second image (12), {c^{R}ᵢ₁, c^{R}ᵢ₂, . . . , c^{R}_{iN}}⊆cᵢ and {c^{T}ⱼ₁, c^{T}ⱼ₂, . . . , c^{T}_{jN}}⊆cⱼ;
calculate the difference between cᵢ and cⱼ using the following equations:
$$\begin{matrix}D ( {c}_{i} , {c}_{j} ) = [ 1 + \frac{1}{N} {\sum }_{m = 1}^{N} d ( {c}_{im} , {c}_{jm} ) ] {( \frac{{n}_{i} + {n}_{j}}{2 N} )}^{k} \\ S ( {c}_{i} , {c}_{j} ) = exp ( \frac{1}{2 σ} {( 1 - D ( {c}_{i} , {c}_{j} ) )}^{2} )\end{matrix} ,$$
in which:
D (cᵢ, cⱼ): difference between cᵢ and cⱼ;
S(cᵢ, cⱼ): similarity between cᵢ and cⱼ;
a: distance to similarity score conversion flexibility parameter;
d (c^{R}ₘ, c^{T}ₘ) is the distance, in the L2 norm, between two descriptors (16) c^{R}ᵢₘ of the first image (11) and c^{T}ⱼₘ of the second image (12);
nᵢ: number of grouping descriptors (17) cᵢ;
nⱼ: number of grouping descriptors (17) cⱼ;
k: penalty parameter for non-corresponding descriptors;
N: number of pairs of descriptors (16) with correspondence (19) found.

7. Method (100) according to claim 6, characterized in that the determining step (140) further comprises:
not consider as matching pairs (19) pairs of elements (17) that are distant from each other by a difference greater than a minimum score, min_score;
find the matching candidates (19), considering, for each of the one or more elements (17) of the second image (11), the element (17) with the highest difference value of the first image (12), also considering the one or more elements (17) whose difference is less than a minimum threshold tolerance value, tol, according to the following relationship:
Candidates(cⱼ)={cᵢ∈C^{R}:S(cᵢ, cⱼ)>max{min_score, S*(cⱼ)−tol}}
in which:
C^{R}: the set of one or more arrays (17) of the first image (11);
C^{T}: set one or more arrays (17) of the second image (12);
S*(cj): maximum similarity value between element cⱼ, among all the elements in the first image (11).

8. Method (100) according to claim 7, characterized in that the winning matching pair (19) will be the one with candidate cᵢ whose relative position is most like grouping cⱼ.

9. Method (100) according to claim 1, characterized in that the determining step (150) further comprises:
capture the one or more elements (17) of C^{T} that are not found as the second component in the set of matching pairs (19) M to form a list of additional elements (14), according to the following relationship:
Additional={cⱼ∈C^{T}:(cᵢ, cⱼ)∉M, ∀cᵢ∈C^{R}}.

10. Method (100) according to claim 9, characterized in that the determining step (150) further comprises:
after the step of not considering as matching pairs, one or more elements (17) of the first image (11) are not present among the pairs of the set of matching pairs (19) M, these one or more elements (17) form a list of missing elements (13), according to the following relationship:
Missing={cᵢ∈C^{R}:(cᵢ, cⱼ)∉M, ∀cⱼ∈C^{T}}.

11. Method (100) according to claim 1, characterized in that the step of checking (160) further comprises:
any pairs of elements (17) whose relative coordinates of a grouping of the second image (12) were more different than a threshold distance, threshold_{distance}, when compared with the coordinates of the corresponding elements (17) of the first image (11), form a list of misplaced elements (15), according to the following relationship:
Misplaced={(cᵢ, cⱼ)∈M:\sqrt{(xᵢ−\hat{x}ⱼ)²+(yᵢ−ŷⱼ)²}≥threshold_{dist}}
where xᵢ and yᵢ represent the positions of each descriptor (16) in the second image (12) and \hat{x}ᵢ and ŷᵢ are the relative positions of each descriptor xᵢ and yᵢ in the first image (11) found in the step of defining a relative position.

12. Method (100) according to claim 1, characterized in that the method further comprises:
provide as output the first image (11) next to the second image (12), where missing elements (13), additional elements (14) and misplaced elements (15) are visually highlighted directly in the first and second images (11, 12);
wherein one or more elements (17) representative of the missing (13) or additional elements (14) are marked with a red colored line around them and the pair of elements (17) checked (160) as misplaced form a matching pair (19) marked in red.

13. Method (100) according to claim 1, characterized in that it further comprises identifying and ignoring undesirable elements based on a list of elements or undesirable areas for validation.

14. Computer-readable storage medium, characterized in that it comprises computer-readable instructions that, when executed by one or more processors, cause one or more processors to perform the method as defined in claim 1.
